(19) United States
(12) Patent Application Publication
(10) Pub. No.: US 2026/0097648 A1
(43) Pub. Date: Apr. 9, 2026

(54) DISPLAYING IMAGES ON A POSITION ADJUSTABLE DISPLAY IN A VEHICLE

(71) Applicant: FCA US LLC, Auburn Hills, MI (US)

(72) Inventors: Daniel P Cashen, Auburn Hills, MI (US); Emily A Robb, Auburn Hills, MI (US); Esaias Pech, Auburn Hills, MI (US)

(21) Appl. No.: 18/910,799

(22) Filed: Oct. 9, 2024

(51) Int. Cl. B60K 35/22; B60R 1/26; G06F 1/16

(52) U.S. Cl. CPC B60K 35/22; B60R 1/26; G06F 1/16; G06F 2200/1614

(57) ABSTRACT

A system and method for displaying images within the interior of a vehicle may include a camera in communication with a controller. The controller may be capable of receiving images from the camera. A position sensor may be communication with the controller so that the controller can obtain the instantaneous position of the display. Upon receiving the instantaneous position of the display, the controller may alter the perspective of the individual images from the video feed from the camera to show a particular portion of the images. The controller may be in communication with the display to show this portion of the images on the display.

### FIELD

The present disclosure relates to a system for displaying images on a position-adjustable display in a vehicle.

### BACKGROUND

Some vehicles include rear-view mirrors that can display part of a field of view of an exterior vehicle camera. The displayed portion of the camera field of view is not adjustable by a user and this causes points of interest near the vehicle to be partially or fully outside of the portion of the field of view or to appear distant and undesirably small within the fixed field of view.

### SUMMARY

In at least some implementations, a method for displaying images in a vehicle comprises the steps of determining an orientation of a display, determining a cropped field of view to display that is a portion of a camera field of view, where the cropped field of view is at least partially based upon the orientation of the display, displaying the cropped field of view on the display.

In at least some implementations, the display is pivotable about a mount.

In at least some implementations, the orientation of the display can be adjusted about an x-axis, a y-axis, and a z-axis.

In at least some implementations, a camera provides a series of consecutive images forming a video feed. The cropped field of view is the same portion of the camera field of view in the consecutive images when the orientation of the display does not change during display of the consecutive images.

In at least some implementations, the portion of the field of view that is the cropped field of view changes when the orientation of the display is changed.

In at least some implementations, the location of the cropped field of view relative to the camera field of view mimics the orientation of the display.

In at least some implementations, the cropped field of view is shifted along at least one of the x, y or z axes when the display is moved about one of the x, y or z axes.

In at least some implementations, a system for displaying images in a vehicle comprises a position sensor to determine an orientation of a display, a controller to determine a cropped field of view at least partially based upon the orientation of the display, and a display to display the cropped field of view.

In at least some implementations, the display is pivotable about a mount.

In at least some implementations, the orientation of the display can be adjusted about an x-axis, a y-axis, and a z-axis.

In at least some implementations, the image is output by a camera of the vehicle, the camera having a camera field of view.

In at least some implementations, the image is a series of consecutive images forming a video feed.

In at least some implementations, the controller adjusts the image creating a cropped field of view that is smaller in size than the camera field of view in at least one of the x, y, and z directions.

In at least some implementations, the portion of the camera field of view that is the cropped field of view changes based on the orientation of the display.

In at least some implementations, the cropped field of view mimics the orientation of the display.

In at least some implementations, the cropped field of view is shifted along at least one of the x, y or z axes when the display is moved in along one of the x, y or z axes.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a forward-facing view of an interior of a vehicle;

FIG. 2 is a top view of an exterior of the vehicle having a camera;

FIG. 3 is a side view of the exterior of the vehicle;

FIG. 4 is a top view of an exterior of a vehicle having a camera;

FIG. 5 is a side view of the exterior of the vehicle of FIG. 4;

FIG. 6 is a schematic diagram of a system for displaying images within the vehicle;

FIG. 7 is a flow chart of a method for displaying images within the vehicle;

FIG. 8 is a diagrammatic view of a rear-view mirror in the interior of the vehicle;

FIG. 9 is a diagrammatic view showing a camera field of view and a cropped field of view that is shown on the display of FIG. 8;

FIG. 10 shows the display rotated to the right about a y-axis;

FIG. 11 shows the cropped field of view based on an orientation of the display in FIG. 10;

FIG. 12 shows the display rotated to the left about the y-axis and down about an x-axis;

FIG. 13 shows the cropped field of view based on an orientation of the display in FIG. 12;

FIG. 14 shows the display rotated to the left about the y-axis and up about the x-axis;

FIG. 15 shows the cropped field of view based on an orientation of the display in FIG. 14;

FIG. 16 shows the display rotated clockwise about a z-axis;

FIG. 17 shows the cropped field of view based on the orientation of the display in FIG. 16;

FIG. 18 shows the display rotated down about the x-axis;

FIG. 19 shows the cropped field of view based on the orientation of the display in FIG. 18.

### DETAILED DESCRIPTION

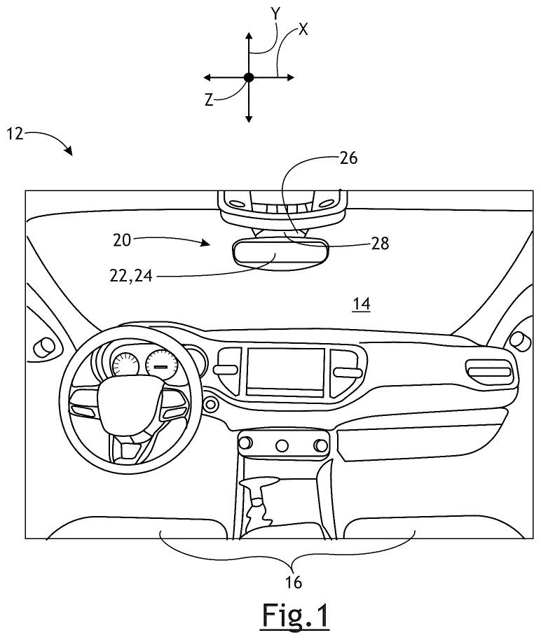

Referring in more detail to the drawings, FIG. 1 shows a forward portion of an interior 12 of a vehicle 10. The interior 12 includes a passenger compartment that is defined in part by a windshield 14, and includes seats 16, vehicle controls (e.g. steering wheel, accelerator and brake pedals, etc) and vehicle system controls 18 (e.g. an infotainment system) that may be operated by one or more vehicle occupants. Attached to or in the area of the windshield 14 is a rear-view assembly 20 that enables a forward-facing driver of the vehicle 10 to see part of the environment behind the driver. The rear-view assembly 20 may include a mirror 22 or a display 24 for a camera image, or both, and a mount 26 by which the rear-view assembly 20 is connected to or near the windshield 14.

The use of a mirror 22 is known and this description will focus on use of the display 24 within the rear-view assembly 20. The display 24 may be of any suitable type and is arranged within the rear-view assembly 20 to enable presentation of images from a camera carried by the vehicle, such as a rear-facing camera. The display 24 may include an array of pixels controlled to emit light such as LCD, LED, OLED, QLED, or others known to those skilled in the art.

In the embodiment shown, the mount 26 may be attached to the vehicle 10 towards the top of the windshield 14. In other embodiments, the mount 26 may be positioned at other locations within the vehicle 10 such as vehicle structures like the roof, or interior panels. The mount 26 may be a ball and socket type mount permitting rotation of the rear-view assembly 20 about one or more of x, y and z axes, to adjust the orientation or angle of the rear-view assembly 20 relative to the person viewing it. Any suitable mount may be used to permit desired adjustments of the rear-view assembly 20. The display 24 is pivotably attached to the mount 26 and positioned for a user to view the display 24 within the interior 12 of the vehicle 10. The orientation of the display 24 relative to the interior 12 of the vehicle 10 may be adjusted by the user along the x, y, and z axes. Upon adjustment of the orientation, the display 24 may remain in the adjusted position relative to the mount 26 until further adjustments are made by the user.

The rear-view assembly 20 may include a position sensor 28 that is capable of determining the orientation of the display 24 relative to the mount 26 or other reference. The position sensor 28 may be integrated with the display 24 or the mount 26 and may be any sensor suitable for determining the orientation of the display 24, including but not limited to an accelerometer, a laser displacement system, an optical sensor, among others.

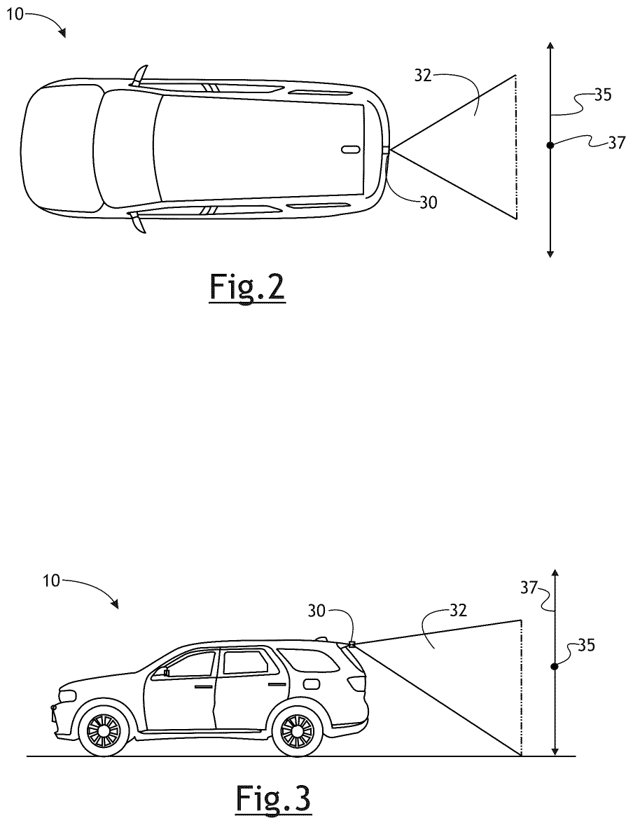

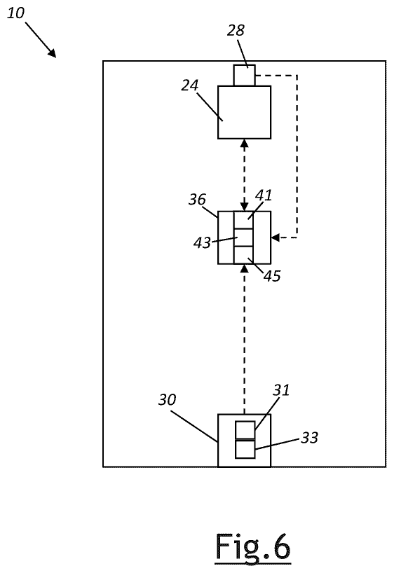

Referring to FIGS. 2-5, a rear-facing camera 30 is mounted to the rear of the vehicle 10. The camera 30 is configured to capture a video feed and as generally shown in FIG. 6, may have an aperture and lens, an image sensor 31 31, and an image processor 33. The image sensor 31 may be an electronic component capable of converting light into electrical signals readable by the image processor 33 as a digital image having a width along the x-axis 35 and a height along the y axis 37. The image processor 33 may be integrated with the camera 30 or may be a separate component located somewhere else within the vehicle 10 and in communication with the camera 30.

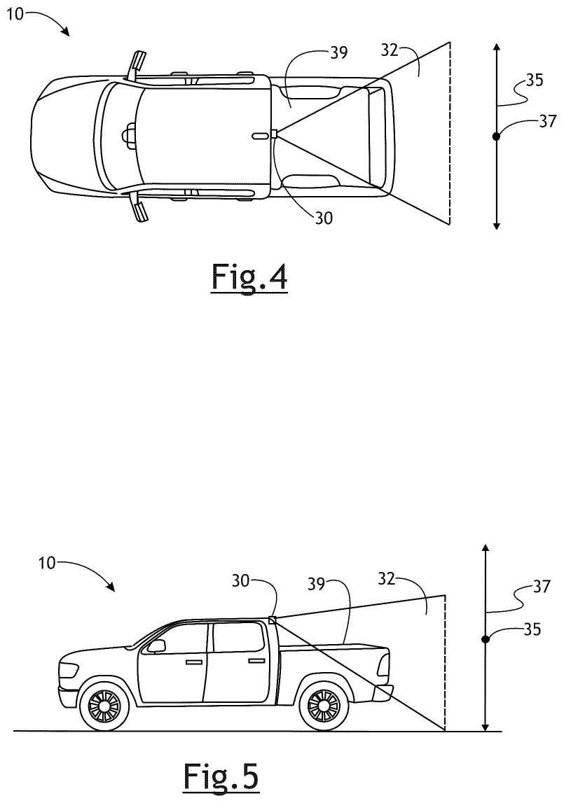

As shown by FIGS. 2-4, the camera 30 may have a field of view 32 spanning horizontally along the x-axis 35 and vertically along the y-axis 37. The field of view 32 might match the digital image dimensions, or the digital image may be a cropped portion of the total field of view 32 of the camera 30. The size and profile of the field of view 32 along the x- and y-axes 35, 37 depend, for example, on the configuration of the lens of the camera 30 and may vary in different embodiments. In at least some embodiments, as the distance from the camera 30 increases the size of the field of view 32 increases. While FIGS. 2-3 show the camera 30 mounted to the rear of the vehicle 10, it is possible to mount the camera 30 in other locations. As shown in FIGS. 4-5 some vehicles 10, such as trucks, the camera 30 may be positioned spaced from the rear of the vehicle 10 to, for example, have a portion of the vehicle 10, such as a truck bed 39, within the field of view 32.

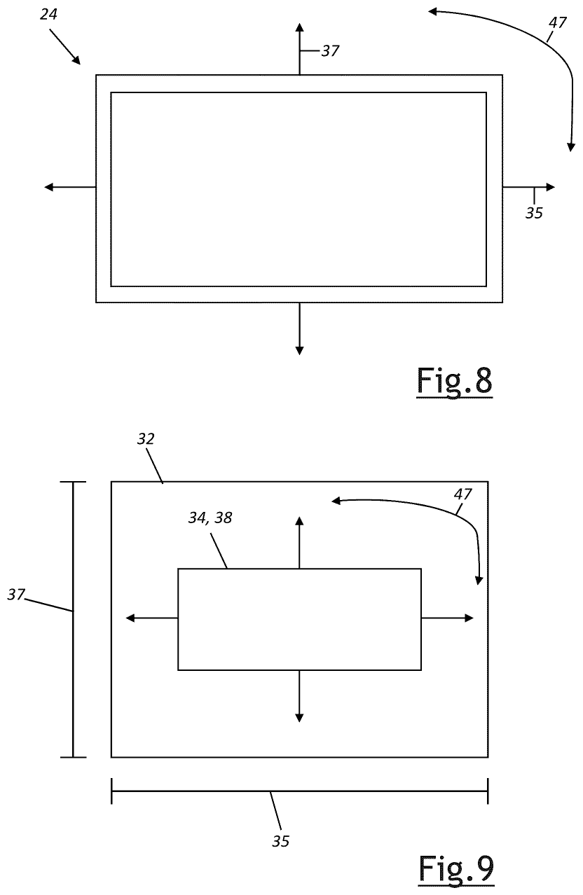

As shown in FIG. 8, the display 24 may comprise some or all of a front face of the rear-view assembly 20. The display size 34 may be characterized by a number of pixels or other dimensions in the x and y directions (e.g along the x- and y-axes 35, 37). Further, FIG. 9 shows the camera field of view 32 as a large rectangle and the display size 34, which is shown by the smaller rectangle. In other words, the display 24, when showing an image from the camera, shows only a portion of the field of view 32 of the camera, or only a portion of the image produced by the camera 30 (e.g. the image processor 33). This may occur, for example, because the display 24 has a different ratio of height to width and so the digital image cannot be scaled to fit on the display 24 without distortion. Thus, the displayed image is a cropped portion of the camera field of view 32 or the image produced by the camera 30. That is, the displayed image is smaller than the camera field of view 32 or the image produced by the camera 30 in at least one dimension.

FIG. 6 shows a schematic of the system for displaying images within the interior 12 of a vehicle 10. The camera 30 may communicate with a controller 36, and the controller 36 is capable of receiving image data from the camera 30 and for providing image data to the display 24. The controller 36 has memory 41 capable of storing information and programs, and one or more processors 43 capable of, among other things, reading from the memory and executing programs 45 stored in the memory. The position sensor 28 is in communication with the controller 36 so that the controller 36 can obtain the instantaneous position of the display 24. Based on the position of the display 24, the controller 36 may alter the portion of the field of view 32 or image from the camera 30 that is shown on the display 24 to show a particular portion of the camera images.

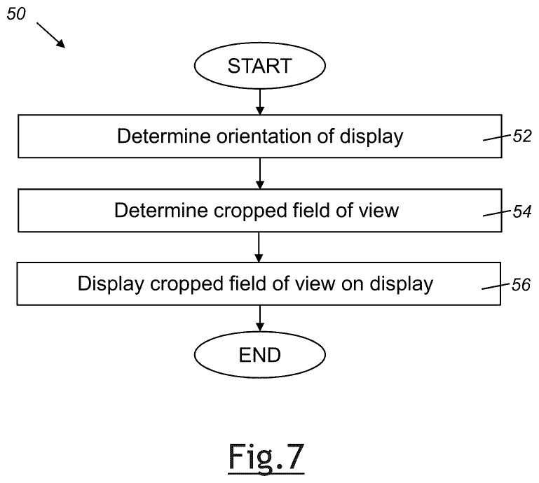

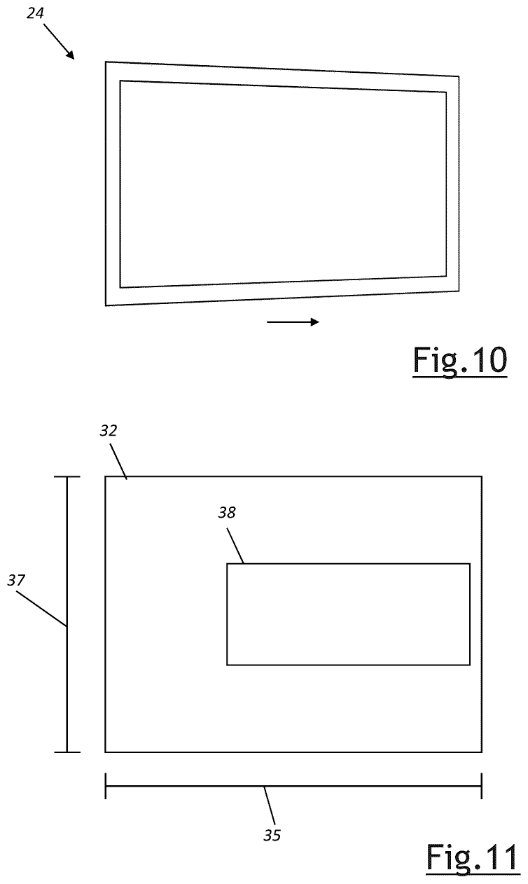

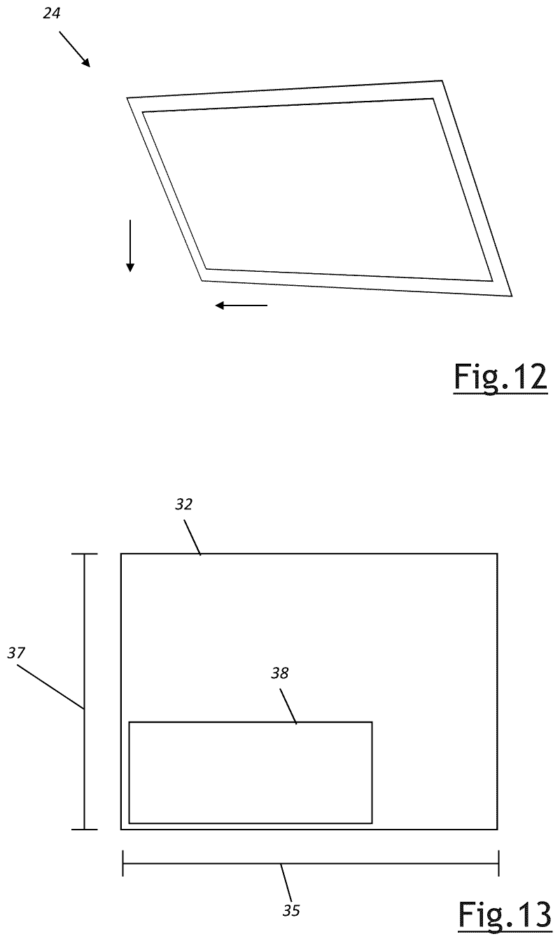

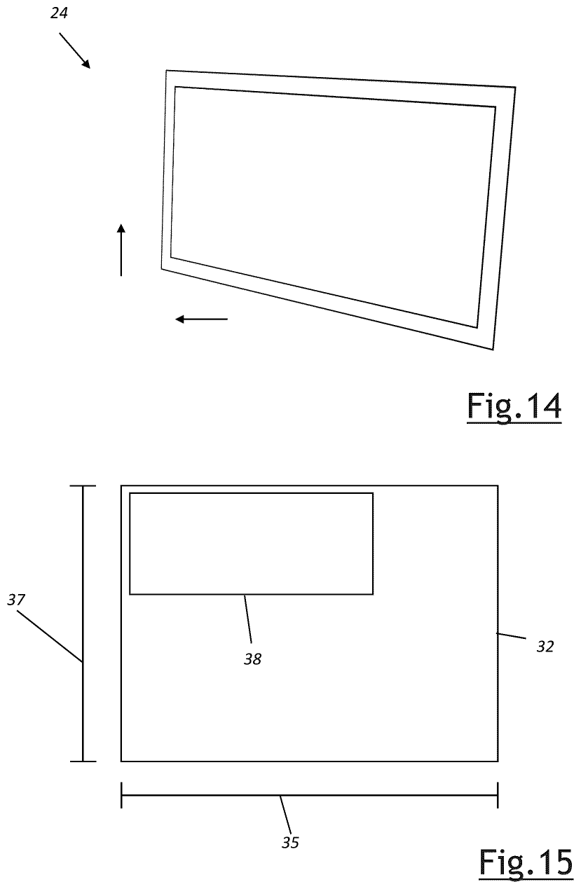

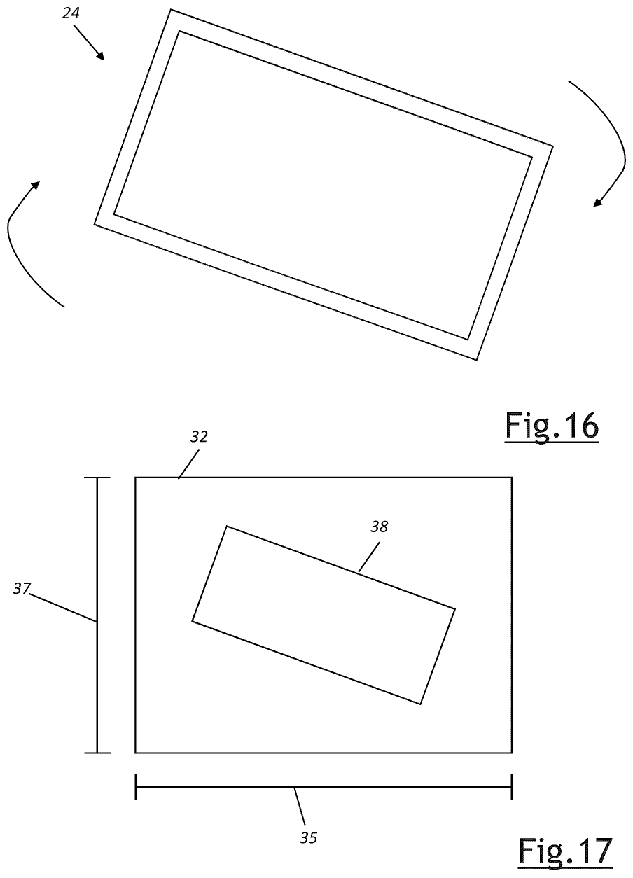

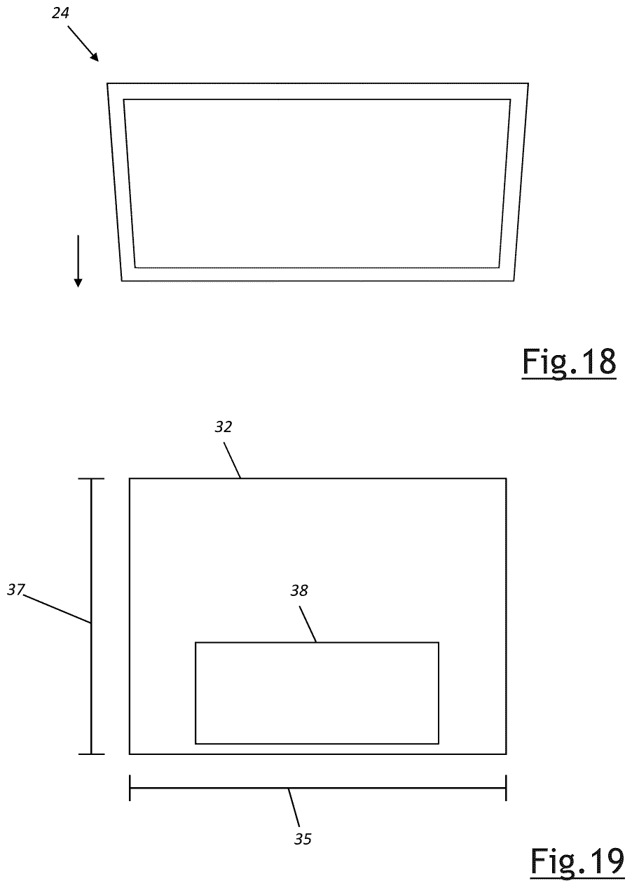

FIG. 7 shows a flowchart of a method 50 for displaying images in a vehicle 10. In step 52, the orientation of the display 24 is determined and this may be done by the controller 36 in response to information from the position sensor 28, which may track the position of the display 24, in real-time or as desired. To demonstrate some of the possible positions of the display 24, FIG. 8 shows the display 24 in a neutral position for all axes. FIG. 10 shows the display 24 rotated to the right about the y-axis 37 but the display 24 remains centered about the x- and z-axes 35, 47. FIG. 12 shows the display 24 rotated to the left about the y-axis 37 and rotated down about the x-axis 35. FIG. 14 shows the display 24 rotated to the left about the y-axis 37 and up about the x-axis 35. FIG. 16 shows the display 24 rotated clockwise about the z-axis 47. FIG. 18 shows the display 24 rotated down along the x-axis 35 and centered on the y- and z-axes 37, 47. During adjustment of the display 24 by the user, the display 24 may be moved as physically permitted by the mount 26 in any combination of the three axes 35, 37, 47.

In step 54, the portion of the video feed from the camera 30 that is shown on the display 24 is adjusted at least partially based upon the position of the display 24. In this step, the camera 30 captures a video feed of images and passes them to the controller 36. The controller 36 takes the video feed and the orientation of the display 24 from the position sensor 28 as inputs. As noted above, due to constraints such as the size and location of the display 24, it may not be preferred to show the entire field of view 32. Therefore, the controller 36 may select a zoomed-in or cropped portion of the field of view 32 known as the cropped field of view 38 to be provided on the display 24. The cropped field of view 38 may be less than the entire field of view 32 of the camera 30 in one or more of the x and y directions. To choose the cropped field of view 38 to be shown on the display 24 out of the camera's 30 field of view 32, the user may move the display 24 about the mount 26 about the x, y, and z axes 35, 37, 47. Once moved, the controller 36 may receive the position of the display 24 from the position sensor 28 and adjust the cropped field of view 38.

In step 56, the cropped field of view 38 is shown on the display 24 to mimic the instantaneous or current positions of the display 24. The specific size and location of the cropped field of view 38 relative to the field of view 32 of the camera 30 varies by the implementation, however, in most implementations the location of the cropped field of view 38 generally follows orientation of the display 24.

For example, FIG. 9 shows the field of view 32 of the camera 30 that is input to the controller 36 and the cropped field of view 38 that is based on a neutral orientation of the display 24 that is sent to the display 24 from the controller 36. The cropped field of view 38 may be adjusted about x, y, and z axes 35, 37, 47 to include different portions of the field of view 32 based on the orientation of the display 24. To illustrate operation of the method 50, FIG. 10 shows the display 24 rotated to the right about the y-axis 37. This orientation is sent to the controller 36, and, as shown in FIG. 11, the controller 36 crops the video feed to a predetermined size creating a cropped field of view 38 and shifts the cropped field of view 38 towards the right along the x-axis 35 to show an area behind and towards the right of the vehicle 10 on the display 24.

In another example, as shown in FIG. 12, the display 24 is rotated towards the left about the y-axis 37 and down about the x-axis 35. Therefore, as shown in FIG. 13, the controller 36 creates a cropped field of view 38 that is shifted (e.g. relative to the neutral position of FIGS. 8 and 9) towards the left along the x-axis 35 and down along the y-axis 37 of the field of view 32 of the camera 30. This cropped field of view 38 then shows, among other things, an area to the left behind the vehicle 10 and along the ground surface. Therefore, the user in the interior 12 of the vehicle 10 can view on the display 24 the area behind the vehicle 10 towards the left along the ground surface.

In yet another example, as shown in FIG. 14, the display 24 is rotated towards the left about the y-axis 37 and up about the x-axis 35. Therefore, as shown in FIG. 15, the controller 36 creates a cropped field of view 38 that is shifted towards the left along the x-axis 35 and up along the y-axis 37 of the field of view 32 of the camera 30. This cropped field of view 32 specifically shows an area to the left behind the vehicle 10 and elevated from the ground surface. Therefore, the user in the interior 12 of the vehicle 10 can view on the display 24 the area behind the vehicle 10 towards the left above the ground surface (and whatever else is shown in the cropped field of view 38).

In some implementations, as shown in FIG. 16, the user may change the orientation of the display 24 in the z-direction in counterclockwise or clockwise directions relative to the mount 26. FIG. 16 shows the display 24 rotated clockwise about the z-axis 47. Based on this clockwise orientation of the display 24, as shown in FIG. 17, the controller 36 creates a cropped field of view 38 that is rotated clockwise in the z-direction and outputs the cropped field of view 38 to the display 24.

In another implementation, as shown in FIG. 18, the user may rotate the display 24 down about the x-axis 35. This may also be useful in embodiments where a portion of the field of view 32 contains a portion of the vehicle 10, such as the truck bed in the embodiment shown by FIGS. 4-5. Based on this orientation of the display 24, as shown in FIG. 19, the controller 36 creates a cropped field of view 38 that is shifted down along the y-axis 37. The user may then view an area immediately behind the vehicle 10 that in some implementations may include a portion of the vehicle 10 such as a truck bed. Thus, showing the user any objects near the vehicle 10 or on/within the portion of the vehicle 10 visible in the cropped field of view 38.

The systems and methods adjust an image shown on a vehicle 10 display 24 as the position or orientation of vehicle 10 display 24 is adjusted. While noted in the examples above as being rotated about various axes, other movements including linear and other non-linear movements may be provided, as desired, by suitable mounts 26 for the display 24. The camera 30 output used to provide displayed images on the position adjustable display 24 may be used for other purposes in the vehicle 10. For example, the rear-facing camera 30 may be used as a back-up camera and an image of a different size or scale may be provided on a screen within the vehicle 10 different from the display 24, such as but not limited to a dashboard mounted display of an infotainment system, or a heads-up display on or near the windshield 14. Permitting adjustment of the image shown based on the orientation or position of the rear-view assembly 20 permits a user to see different portions of the camera 30 field of view 32, as desired.

What is claimed is:

1. A method for displaying images in a vehicle, the method comprising the steps of:
determining an orientation of a display;
determining a cropped field of view to display that is a portion of a camera field of view, where the cropped field of view is at least partially based upon the orientation of the display;
displaying the cropped field of view on the display.

2. The method of claim 1 wherein, the display is pivotable about a mount.

3. The method of claim 2 wherein, the orientation of the display can be adjusted about an x-axis, a y-axis, and a z-axis.

4. The method of claim 1 wherein, a camera provides a series of consecutive images forming a video feed, and wherein the cropped field of view is the same portion of the camera field of view in the consecutive images when the orientation of the display does not change during display of the consecutive images.

5. The method of claim 4 wherein, the portion of the camera field of view that is the cropped field of view changes when the orientation of the display is changed.

6. The method of claim 5 wherein, the location of the cropped field of view relative to the camera field of view mimics the orientation of the display.

7. The method of claim 6 wherein, when the display is moved about one of the x, y or z axes, the cropped field of view is shifted along at least one of the x, y or z axes.

8. A system for displaying images in a vehicle, the system comprising:
a position sensor to determine an orientation of a display;
a controller to determine a cropped field of view at least partially based upon the orientation of the display;
a display to display the cropped field of view.

9. The system of claim 8 wherein, the display is pivotable about a mount.

10. The system of claim 9 wherein, the orientation of the display can be adjusted about an x-axis, a y-axis, and a z-axis.

11. The system of claim 8, wherein, the image is output by a camera of the vehicle, the camera having a camera field of view.

12. The system of claim 11 wherein, the image is a series of consecutive images forming a video feed.

13. The system of claim 12 wherein, the controller adjusts the image creating a cropped field of view that is smaller in size than the camera field of view in at least one of the x, y, and z directions.

14. The system of claim 13 wherein, the portion of the camera field of view that is the cropped field of view changes based on the orientation of the display.

15. The system of claim 14 wherein, the cropped field of view mimics the orientation of the display.

16. The system of claim 14 wherein, when the display is moved in along one of the x, y or z axes, the cropped field of view is shifted along at least one of the x, y or z axes.
